(19) United States
(12) Patent Application Publication
(10) Pub. No.: US 2024/0013132 A1
(43) Pub. Date: Jan. 11, 2024

(54) MANAGEMENT APPARATUS, MANAGEMENT SYSTEM, MANAGEMENT METHOD, AND MOBILE OBJECT

(71) Applicant: TOYOTA JIDOSHA KABUSHIKI KAISHA, Aichi-ken (JP)

(72) Inventors: Masatoshi HAYASHI, Nisshin-shi (JP); Josuke YAMANE, Nagoya-shi (JP); Daigo FUJII, Nagoya-shi (JP); Yuki TATSUMOTO, Seto-shi (JP); Takurou SAKAI, Setagaya-ku (JP)

(21) Appl. No.: 18/346,862

(22) Filed: Jul. 5, 2023

(30) Foreign Application Priority Data
Jul. 6, 2022 (JP) 2022-109279

(51) Int. Cl. G06Q 10/083; B60W 60/00; B60W 40/02

(52) U.S. Cl. CPC G06Q 10/083; B60W 60/00256; B60W 40/02; B60W 2555/20

(57) ABSTRACT

A management apparatus includes a controller configured to manage a mobile object for delivering a delivery article by placing the delivery article at a delivery position. The controller is configured to determine the delivery position based on environmental information for a delivery destination and control the mobile object to place the delivery article at the delivery position.

### CROSS-REFERENCE TO RELATED APPLICATION

This application claims priority to Japanese Patent Application No. 2022-109279, filed on Jul. 6, 2022, the entire contents of which are incorporated herein by reference.

### TECHNICAL FIELD

The present disclosure relates to a management apparatus, a management system, a management method, and a mobile object.

### BACKGROUND

Systems in which automated vehicles deliver packages are known. For example, see Patent Literature (PTL) 1.

### CITATION LIST

### Patent Literature

PTL 1: JP 2020-181287 A

### SUMMARY

In cases in which a package is placed at a delivery destination (the case of so-called unattended delivery), the package might be affected by the environment of the location where the package is placed.

It would be helpful to reduce the effect of the environment on packages placed at delivery destinations.

A management apparatus according to an embodiment of the present disclosure includes a controller configured to manage a mobile object for delivering a delivery article by placing the delivery article at a delivery position. The controller is configured to determine the delivery position based on environmental information for a delivery destination and control the mobile object to place the delivery article at the delivery position.

A management system according to an embodiment of the present disclosure includes the aforementioned management apparatus and a mobile object for delivering a delivery article.

A management method according to an embodiment of the present disclosure includes managing a mobile object for delivering a delivery article by placing the delivery article at a delivery position. The management method includes determining the delivery position based on environmental information for a delivery destination and controlling the mobile object to place the delivery article at the delivery position.

A mobile object according to an embodiment of the present disclosure delivers a delivery article by placing the delivery article at a delivery position. The mobile object includes a controller configured to determine the delivery position based on environmental information for a delivery destination.

According to the management apparatus, the management system, the management method, and the mobile object in an embodiment of the present disclosure, the effect of the environment on packages placed at delivery destinations can be reduced.

### BRIEF DESCRIPTION OF THE DRAWINGS

In the accompanying drawings:

FIG. 1 is a block diagram illustrating an example configuration of a management system according to an embodiment;

FIG. 2 is a diagram schematically illustrating an example configuration of a mobile object;

FIG. 3 is a flowchart illustrating an example procedure of a management method according to an embodiment; and

FIG. 4 is a flowchart illustrating an example procedure of a management method according to another embodiment.

### DETAILED DESCRIPTION

(Example Configuration of Management System 1)

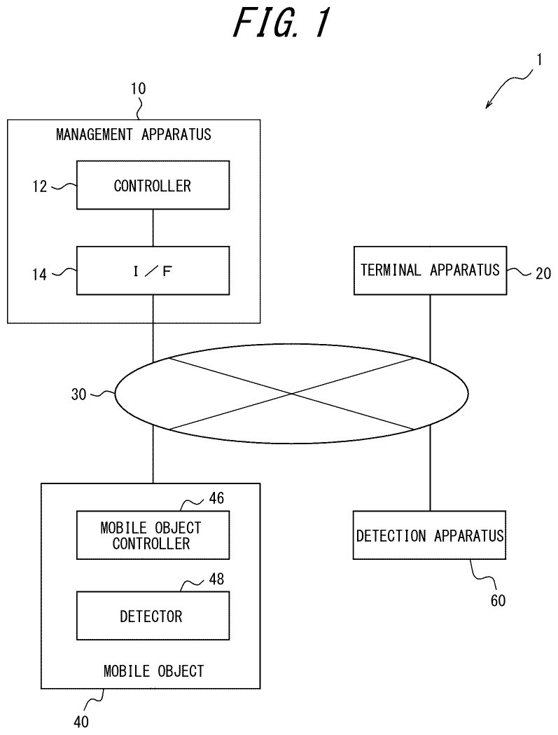

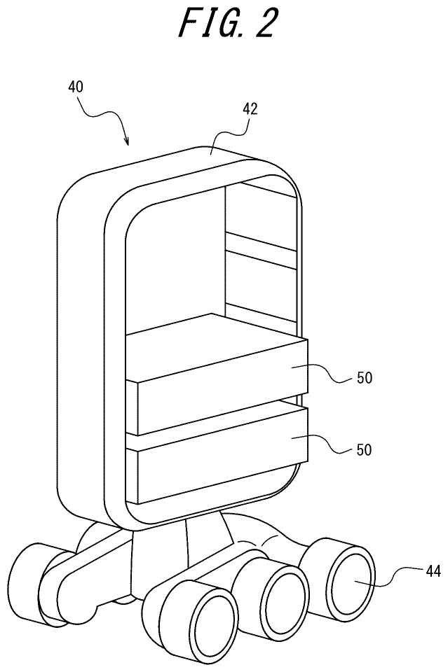

As illustrated in FIG. 1, a management system 1 according to an embodiment includes a management apparatus 10 and a mobile object 40. The mobile object 40 delivers delivery articles 50 (see FIG. 2) by storing the delivery articles 50 and traveling to the delivery destinations. The management apparatus 10 manages the travel route or travel schedule for the mobile object 40 to deliver the delivery articles 50.

The mobile object 40 may deliver a delivery article 50 by traveling to the delivery destination and allowing the user to receive the delivery article 50 directly. The mobile object 40 may deliver a delivery article 50 by placing the delivery article 50 at the delivery destination. In other words, the mobile object may perform so-called unattended delivery. The management apparatus 10 determines whether the mode of delivery of a delivery article 50 is direct receipt of the delivery article 50 by the user at the delivery destination or placement of the delivery article 50 at the delivery destination. The management apparatus 10 controls the mobile object 40 based on the mode of delivery of the delivery article 50.

The position at which the mobile object 40 places the delivery article 50 at the delivery destination is also referred to as the delivery position. If the delivery article 50 were placed in a location that is wet due to a liquid such as water, the delivery article 50 would become wet or dirty. Furthermore, if the delivery article 50 were placed at a location with an odor due to gas or the like, the odor might stick to the delivery article 50. In other words, the delivery article 50 is affected by the environment at the delivery position.

The management apparatus 10 acquires information on the environment of the delivery destination. The information on the environment of the delivery destination is also referred to as environmental information. The management apparatus 10 may determine the delivery position based on the environmental information in a case in which placement of the delivery article 50 is specified as the mode of delivery. The management apparatus 10 may determine not to place the delivery article 50 at the delivery destination based on the environmental information even in a case in which placement of the delivery article 50 is specified as the mode of delivery. In other words, the management apparatus 10 may determine the mode of delivery of the delivery article 50 based on the environmental information. The management apparatus 10 controls the mobile object 40 to deliver the delivery article 50 in the determined delivery mode.

A specific example configuration of the management system 1 will be described below.

<Management Apparatus 10>

The management apparatus 10 includes a controller 12 and an interface 14. The interface 14 is also referred to as an I/F 14.

The controller 12 controls at least one component of the management apparatus 10. The controller 12 may be configured to include at least one processor. The “processor” is a general purpose processor, a dedicated processor specialized for specific processing, or the like in the present embodiment but is not limited to these. The controller 12 may be configured to include at least one dedicated circuit. The dedicated circuit may include, for example, a field-programmable gate array (FPGA) or an application specific integrated circuit (ASIC). The controller 12 may be configured with the dedicated circuit instead of the processor or may be configured with the dedicated circuit along with the processor.

The management apparatus 10 may further include a memory. The memory is a semiconductor memory, a magnetic memory, an optical memory, or the like, for example, but not limited to these. The memory may function, for example, as a main memory, an auxiliary memory, or a cache memory. The memory may include an electromagnetic storage medium, such as a magnetic disk. The memory may include a non-transitory computer readable medium. The memory stores any information used for operation of the management apparatus 10. For example, the memory may store a system program, an application program, or the like. The memory may be included in the controller 12.

Information, data, or the like is outputted from and inputted to the controller 12 through the I/F 14. The I/F 14 may include a communication module for communication with other apparatuses, such as the mobile object 40 or the terminal apparatus 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The I/F 14 may be configured to be connected to the communication module.

The I/F 14 may be configured with an input device for receiving inputs, such as information or data, from a user. The input device may be configured with, for example, a touch panel, a touch sensor, or a pointing device such as a mouse. The input device may be configured with a physical key. The input device may be configured with an audio input device, such as a microphone.

The I/F 14 may be configured to include an output device that outputs information, data, or the like to the user. The output device may include, for example, a display device that outputs visual information, such as images, letters, or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information, such as voice. The output device is not limited to the above examples and may include various other devices.

The management apparatus 10 may include a single server apparatus or multiple server apparatuses capable of communicating with each other.

<Mobile Object 40>

As illustrated in FIG. 2, the mobile object 40 includes a body 42, with a storage space for storing delivery articles 50, and a drive unit 44 for moving the mobile object 40.

The storage space of the body 42 may be configured to store delivery articles 50 packed in delivery boxes or the like or may be configured to store delivery articles 50 that are not packed in delivery boxes or the like. The body 42 may be equipped with a locking mechanism configured to lock the delivery articles 50 stored in the storage space. The body 42 may have an opening for loading and unloading the delivery articles 50 onto and off the storage space. The body 42 may have an entrance and exit, including a door or shutter that opens when delivery articles 50 are loaded onto or unloaded off the storage space.

The drive unit 44 may, for example, include wheels or caterpillars as a mechanism for traveling on a road surface. The drive unit 44 may further include a drive mechanism such as a motor or engine that drives the wheels, caterpillars, or the like. The drive unit 44 may further include components such as gears that transmit power from the drive mechanism to the wheels, caterpillars, or the like. The drive unit 44 may further include a battery to supply power or a tank to supply fuel to the drive mechanism. The drive unit 44 may include a propeller or an injection apparatus, for example, as a mechanism for flying through the air.

The mobile object 40 may further include a non-essential mobile object controller 46. The mobile object controller 46 controls at least one component of the mobile object 40, such as the body 42 or drive unit 44 of the mobile object 40. The mobile object controller 46 may acquire destination information specifying a destination from the management apparatus 10 and control the drive unit 44 to travel autonomously based on the destination information. The mobile object 40 may acquire control information indicating the timing at which to start or stop traveling, the travel speed, or the like from the management apparatus 10 and control the drive unit 44 to travel based on the control information. In a case in which a delivery article 50 is stored in the body 42, the mobile object controller 46 may output information identifying the stored delivery article 50 to the management apparatus 10. In a case in which a delivery article 50 is removed from the body 42, the mobile object controller 46 may output information identifying the removed delivery article 50 to the management apparatus 10.

The mobile object controller 46 may be configured to include at least one processor. The mobile object controller 46 may be configured to include one or more dedicated circuits instead of the processor, or may be configured to include a dedicated circuit along with the processor. The mobile object 40 may be configured to include a memory. The memory of the mobile object 40 may be configured to be identical or similar to the memory of the management apparatus 10. The mobile object 40 may be configured to include an I/F or a communication module. The I/F or communication module of the mobile object 40 may be configured to be identical or similar to the I/F or communication module of the management apparatus 10.

The mobile object 40 may further include a non-essential detector 48. The detector 48 detects environmental information for the delivery destination. The detector 48 may, for example, detect information on the weather at the delivery destination as the environmental information. As the information on the weather at the delivery destination, the detector 48 may detect whether there is precipitation such as rain, snow, sleet, or hail at the delivery destination. As the environmental information, the detector 48 may detect whether there is standing water or flowing water at the candidate location for placement of the delivery article 50 at the delivery destination. As the environmental information, the detector 48 may detect whether the candidate location for placement of the delivery article 50 at the delivery destination is dirty due to mud or the like.

The detector 48 may be configured to include a camera. The detector 48 may detect the weather at the delivery destination based on images captured by the camera. The detector 48 may detect locations with standing water or flowing water at the delivery destination based on images captured by the camera. The detector 48 may detect locations that are wet at the delivery destination based on images captured by the camera. The detector 48 may be configured to include a sensor that detects water. The detector 48 may detect locations that are dirty at the delivery destination based on images captured by the camera. The detector 48 may be configured to include a sensor that detects dirt.

The detector 48 may emit electromagnetic waves towards a target for detection of water, dirt, or the like and detect the intensity, phase, or the like of the electromagnetic waves reflected back by the target. The detector 48 may detect locations that are wet or dirty at the delivery destination based on the detected reflected electromagnetic waves.

The detector 48 may detect information about the odor at the delivery destination as the environmental information. The detector 48 may be configured to include an odor sensor.

The detector 48 outputs the detected environmental information to the management apparatus 10. The detector 48 may output the detected environmental information to the mobile object controller 46.

The mobile object 40 may be configured to include a positional information detector that acquires the positional information for the mobile object 40 itself. The mobile object 40 may output the positional information for the mobile object 40 itself to the management apparatus 10. The positional information detector may be configured to include a receiver compliant with a satellite positioning system. The receiver compliant with the satellite positioning system may include, for example, a Global Positioning System (GPS) receiver.

The number of mobile objects 40 managed by the management system 1 may be two or more. The mobile object 40 is not limited to the configuration illustrated in FIG. 2 but may be configured in a variety of other ways to store the delivery articles 50 and move.

<Detection Apparatus 60>

The management system 1 may further include a non-essential detection apparatus 60. The detection apparatus 60 detects environmental information at the delivery destination. The detection apparatus 60 may be installed at the delivery destination. As the environmental information, the detection apparatus 60 may, for example, detect information on the weather at the delivery destination. As the environmental information, the detection apparatus 60 may detect whether there is standing water or flowing water at a candidate location for placement of the delivery article 50 at the delivery destination.

The detection apparatus 60 may be configured to include a camera. The detection apparatus 60 may detect the weather at the delivery destination based on images captured by the camera. The detection apparatus 60 may detect locations with standing water or flowing water at the delivery destination based on images captured by the camera. The detection apparatus 60 may detect locations that are wet at the delivery destination based on images captured by the camera. The detection apparatus 60 may be configured to include a sensor that detects water. The detection apparatus 60 may detect locations that are dirty at the delivery destination based on images captured by the camera. The detection apparatus 60 may be configured to include a sensor that detects dirt.

The detection apparatus 60 may emit electromagnetic waves towards a target for detection of water, dirt, or the like and detect the intensity, phase, or the like of the electromagnetic waves reflected back by the target. The detection apparatus 60 may detect locations that are wet or dirty at the delivery destination based on the detected reflected electromagnetic waves.

The detection apparatus 60 may detect information about the odor at the delivery destination as the environmental information. The detection apparatus 60 may be configured to include an odor sensor.

The detection apparatus 60 outputs the detected environmental information to the management apparatus 10.

<Terminal Apparatus 20>

The management system 1 may further include a non-essential terminal apparatus 20. The terminal apparatus 20 accepts input of information, from the user who is to receive the delivery article 50, specifying the mode of delivery of the delivery article 50 and outputs the inputted information to the management apparatus 10. In a case in which delivery by placement of the delivery article 50 is specified, the terminal apparatus 20 accepts input of information specifying the location for placement of the delivery article 50 and outputs the inputted information to the management apparatus 10. In a case in which delivery by handing the delivery article 50 to the user is specified, the terminal apparatus 20 accepts input of information specifying the location and time for delivery of the delivery article 50 and outputs the inputted information to the management apparatus 10.

The terminal apparatus 20 may acquire information about the delivery status of the delivery article 50 from the management apparatus 10 and notify the user who is to receive the delivery article 50 of the delivery status of the delivery article 50.

The terminal apparatus 20 may be configured to include one or more processors or one or more dedicated circuits. The terminal apparatus 20 may be configured to include a memory. The memory of the terminal apparatus 20 may be configured to be identical or similar to the memory of the management apparatus 10. The terminal apparatus 20 may be configured to include an I/F or a communication module. The I/F or communication module of the terminal apparatus 20 may be configured to be identical or similar to the I/F or communication module of the management apparatus 10.

The terminal apparatus 20 may be configured to include an input device for receiving inputs, such as information or data, from the user. The input device may be configured to include the various devices described as the I/F 14. The terminal apparatus 20 may be configured to include an output device that outputs information, data, or the like to the user. The output device may be configured to include the various devices described as the I/F 14.

The number of terminal apparatuses 20 included in the management system 1 is not limited to one and may be two or more. The terminal apparatus 20 may be configured as a mobile terminal, such as a smartphone or a tablet, or a Personal Computer (PC), such as a notebook PC or a tablet PC. The terminal apparatuses 20 are not limited to the above examples and may include various devices.

(Operation Example of Management System 1)

In the management system 1 according to the present embodiment, the controller 12 of the management apparatus 10 manages the mobile object 40. In a case in which the management system 1 includes a plurality of mobile objects 40, the controller 12 may manage each mobile object 40. The controller 12 generates a travel route or travel schedule for the mobile object 40 so that the mobile object 40 delivers the delivery articles 50 to the delivery destinations.

The controller 12 controls the mobile object 40 to move based on the delivery destination of the delivery articles 50 that the mobile object 40 is storing. The controller 12 acquires environmental information for the delivery destination. The controller 12 may acquire the environmental information after the mobile object 40 arrives at the delivery destination or before the mobile object 40 arrives at the delivery destination.

In a case in which the delivery mode of the delivery article 50 is unattended delivery, the controller 12 determines the delivery position of the delivery article 50 based on the environmental information for the delivery destination. The controller 12 may determine the delivery position after the mobile object 40 arrives at the delivery destination or before the mobile object 40 arrives at the delivery destination.

<Determination of Delivery Position Based on Information on Weather at Delivery Destination>

The controller 12 may acquire information on the weather at the delivery destination as the environmental information for the delivery destination. The controller 12 may acquire information on the weather at the delivery destination from an external apparatus, from the detector 48 of the mobile object 40, or from the detection apparatus 60 installed at the delivery destination. The controller 12 may determine a location, as the delivery position, where the effect of precipitation on the delivery article 50 is reduced when the delivery article 50 is placed at the delivery destination in a case in which there is precipitation at the delivery destination (rain, snow, or the like). The controller 12 may determine a location where the amount of rain, snow, or the like that will fall on the delivery article 50 is reduced as the delivery position. The controller 12 may determine a location where rain, snow, or the like does not fall on the delivery article 50 as the delivery position.

The controller 12 may acquire the amount of precipitation at the delivery destination. The controller 12 may determine a location, as the delivery position, where the amount of rain, snow, or the like that will fall on the delivery article 50 from the time the delivery article 50 is placed at the delivery destination until the delivery article 50 is collected by the user is less than an allowable amount, based on the amount of precipitation at the delivery destination. The controller 12 may set the allowable amount based on the state of packaging of the delivery article 50 or the content of the delivery article 50.

As discussed above, the controller 12 may determine a location where the effect of precipitation is reduced as the delivery position in a case in which there is precipitation at the delivery destination.

The controller 12 may acquire a weather forecast for the delivery destination as the environmental information for the delivery destination. The controller 12 may acquire the weather forecast from an external apparatus. The controller 12 may acquire information on a prediction of precipitation at the delivery destination as the weather forecast for the delivery destination. The controller 12 may acquire the probability of precipitation at the delivery destination as the information on the prediction of precipitation at the delivery destination. Even in a case in which there is no precipitation when the delivery article 50 is placed at the delivery destination, the controller 12 may determine a location, as the delivery position, where the effect of precipitation on the delivery article 50 would be reduced were precipitation to begin in a case in which the probability of precipitation within a predetermined time after placement of the delivery article 50 is equal to or greater than a predetermined value. The controller 12 may determine a location, as the delivery position, where the amount of rain, snow, or the like falling on the delivery article 50 would be reduced were precipitation to begin. The controller 12 may determine a location, as the delivery position, where rain, snow, or the like would not fall on the delivery article 50 were precipitation to begin.

The controller 12 may acquire the predicted amount of precipitation within a predetermined time after placement of the delivery article 50 as the information on the prediction of precipitation at the delivery destination. The controller 12 may determine a location, as the delivery position, where the amount of rain, snow, or the like that will fall on the delivery article 50 from the time the delivery article 50 is placed at the delivery destination until the delivery article 50 is collected by the user is less than an allowable amount, based on the predicted amount of precipitation.

The controller 12 may acquire the probability of precipitation or the predicted amount of precipitation within a predetermined time defined as the time until the user collects the delivery article 50 placed at the delivery destination. When accepting input from the user specifying unattended delivery, the controller 12 may also accept input of an estimated collection time. The controller 12 may set the predetermined time based on the user's estimated collection time and acquire the probability of precipitation or predicted amount of precipitation within the predetermined time.

The controller 12 may determine a location, as the delivery position, where the amount of rain, snow, or the like that will fall on the delivery article 50 until the delivery article 50 placed at the delivery destination is collected is less than a predetermined amount. Even in a case in which precipitation has already begun when the delivery article 50 is being placed for delivery, the controller 12 may determine a location, as the delivery position, where the amount of rain, snow, or the like that will fall on the delivery article 50 until collection by the user is less than an allowable amount.

In response to user specification, the controller 12 may extract locations serving as candidate delivery positions at the delivery destination. The controller 12 may extract the locations serving as candidate delivery positions based on images captured by the detector 48 of the mobile object 40 or the detection apparatus 60 installed at the delivery destination.

The controller 12 may estimate the amount of rain, snow, or the like that would fall in a case in which the delivery article 50 is placed at the candidate locations. The controller 12 may estimate the amount of rain, snow, or the like that would fall in a case in which the delivery article 50 is placed at each candidate location based on detection results, including images captured by the detector 48 of the mobile object 40 or the detection apparatus 60 installed at the delivery destination. The controller 12 may determine the delivery position from among the candidates so that the amount of rain, snow, or the like that would fall is reduced in a case of placement of the delivery article 50. The controller 12 may determine the candidate for which the amount of rain, snow, or the like that would fall is minimized in a case of placement of the delivery article 50.

As discussed above, the controller 12 may determine a location where the effect of precipitation is reduced as the delivery position in a case in which precipitation is predicted within a predetermined time at the delivery destination.

The controller 12 may determine not to deliver the delivery article 50 by unattended delivery based on information on the weather at the delivery destination. For example, even in a case in which the user who is to receive the delivery article 50 has specified unattended delivery, the controller 12 may decide not to deliver the delivery article 50 by unattended delivery in a case in which there is no location where the amount of rain, snow, or the like that would fall on the delivery article 50 at the delivery destination is less than the allowable amount. The controller 12 may determine not to deliver the delivery article 50 by unattended delivery after the mobile object 40 arrives at the delivery destination. The controller 12 may determine not to deliver the delivery article 50 by unattended delivery before the mobile object 40 arrives at the delivery destination.

In a case in which the controller 12 determines not to deliver the delivery article 50 by unattended delivery, the controller 12 may cancel the delivery by the mobile object 40, control the mobile object 40 to return with the delivery article 50, and reattempt delivery at the next opportunity when the effect of precipitation is reduced. The controller 12 may confirm with the user whether hand delivery instead of unattended delivery is acceptable.

Even in a case in which there is no location where the amount of rain, snow, or the like that would fall on the delivery article 50 is less than the allowable amount at the delivery destination, the controller 12 may install a delivery container capable of storing the delivery article 50 at the delivery destination and determine the installed delivery container as the delivery position. After the user has removed the delivery article 50 from the delivery container, the controller 12 may control the mobile object 40 to collect the empty delivery container.

The controller 12 may notify the user who is to receive the delivery article 50 of information on precipitation in a case in which there is precipitation at the delivery destination or a case in which precipitation is predicted within a predetermined time at the delivery destination. The user might wish to cancel the unattended delivery so that the delivery article 50 does not get wet or dirty due to precipitation. The controller 12 may confirm with the user whether to deliver the delivery article 50 by unattended delivery or whether to cancel delivery and return with the delivery article 50. The controller 12 may confirm with the user whether it is acceptable to change to hand delivery.

The controller 12 may control the mobile object 40 not to place the delivery article 50 at the delivery position in a case in which the user does not desire unattended delivery. That is, the controller 12 may control the mobile object 40 not to place the delivery article 50 at the delivery position based on a selection by a user who is to receive the delivery article 50 in a case in which there is precipitation at the delivery destination or a case in which precipitation is predicted within a predetermined time at the delivery destination.

<Determination of Delivery Position Based on Standing or Flowing Water at Delivery Destination>

The controller 12 may acquire information representing a state of standing water or a state of flowing water, at locations serving as candidates for the delivery position at the delivery destination, as the environmental information for the delivery destination. The controller 12 may determine whether water is standing or flowing at the candidate locations based on images captured by the detector 48 of the mobile object 40 or the detection apparatus 60 installed at the delivery destination. The controller 12 may acquire the results of detection of whether candidate locations are wet by the detector 48 or the detection apparatus 60. The controller 12 may determine the delivery position from among the candidates excluding locations with standing water and locations with flowing water.

The controller 12 may acquire information representing whether there was standing water before or whether there was flowing water before, at locations serving as candidates for the delivery position at the delivery destination, as the environmental information for the delivery destination. The controller 12 may determine whether there was standing water or flowing water before at the candidate locations based on images captured by the detection apparatus 60 installed at the delivery destination. The controller 12 may determine the delivery position from among the candidates excluding locations at which there was standing water and locations at which there was flowing water before.

<Determination of Delivery Position Based on State of Dirtiness at Delivery Destination>

The controller 12 may acquire information representing a state of dirtiness at locations serving as candidates for the delivery position at the delivery destination as the environmental information for the delivery destination. The controller 12 may determine whether the candidate locations are dirty based on images captured by the detector 48 of the mobile object 40 or the detection apparatus 60 installed at the delivery destination. The controller 12 may acquire the results of detection of whether candidate locations are dirty by the detector 48 or the detection apparatus 60. The controller 12 may determine the delivery position from among the candidates excluding dirty locations.

<Determination of Delivery Position Based on Information on Odor at Delivery Destination>

The controller 12 may acquire information on an odor at the delivery destination as the environmental information for the delivery destination. The controller 12 may acquire the results of odor detection by the detector 48 of the mobile object 40 or the detection apparatus 60 installed at the delivery destination. The controller 12 may acquire the results of detection of odor intensity. The controller 12 may acquire the results of detection of the type of gas causing the odor. The controller 12 may estimate changes over time in odor intensity.

In response to user specification, the controller 12 may extract locations serving as candidate delivery positions at the delivery destination. The controller 12 may extract the locations serving as candidate delivery positions based on images captured by the detector 48 of the mobile object 40 or the detection apparatus 60 installed at the delivery destination.

The controller 12 may estimate the intensity of the odor that would stick to the delivery article 50 when the delivery article 50 is placed at the locations serving as candidates for the delivery position based on information on the odor at the locations serving as candidates. The controller 12 may determine the delivery position from among the candidates so that less odor sticks to the delivery article 50. The controller 12 may determine the candidate with the least intense odor that would stick to the delivery article 50 as the delivery position.

The controller 12 may estimate the intensity of the odor that would stick to the delivery article 50 from when the delivery article 50 is placed at the delivery destination until the user collects the delivery article 50. When accepting input from the user specifying unattended delivery, the controller 12 may also accept input of an estimated collection time. The controller 12 may determine a location, as the delivery position, for which a numerical value representing the intensity of the odor that would stick to the delivery article 50 by the time the delivery article 50 placed at the delivery destination is collected is less than an allowable value. The controller 12 may set the allowable value based on the state of packaging of the delivery article 50 or the content of the delivery article 50. The controller 12 may quantify the intensity of the odor as the concentration of the gas causing the odor. The controller 12 may quantify the intensity of the odor by various indices such as odor intensity, odor index, or odor concentration. The controller 12 may determine a location where the numerical value representing the intensity of the odor is smaller as the delivery position. The controller 12 may determine a location where the numerical value representing the intensity of the odor is minimized as the delivery position.

(Example Procedure for Management Method)

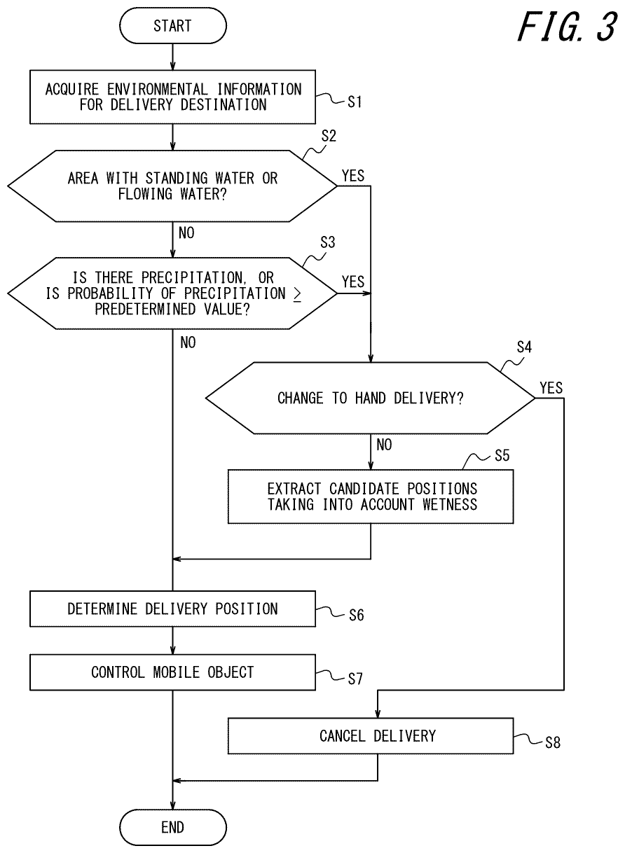

As described above, the management apparatus 10 according to the present embodiment determines the delivery position of the delivery article 50 based on the environmental information for the delivery destination and controls the mobile object 40 to move. The controller 12 of the management apparatus 10 may, for example, perform a management method including the procedures of the flowchart illustrated in FIG. 3 to determine the delivery position. The management method may be implemented as a management program to be executed by the controller 12.

The controller 12 acquires environmental information for the delivery destination (step S1). The controller 12 determines whether there is an area with standing water or flowing water at the delivery destination based on the environmental information for the delivery destination (step S2). In a case in which there is no area with standing water or flowing water (step S2: NO), the controller 12 determines whether there is precipitation at the delivery destination or whether the probability of precipitation within a predetermined time is equal to or greater than a predetermined value (step S3). In a case in which there is no precipitation at the delivery destination and the probability of precipitation within a predetermined time is less than the predetermined value (step S3: NO), the controller 12 proceeds to step S6.

In a case in which there is an area with standing water or flowing water at the delivery destination (step S2: YES), or in a case in which there is precipitation at the delivery destination or the probability of precipitation within a predetermined time is equal to or greater than a predetermined value (step S3: YES), the controller 12 determines whether to change from unattended delivery to hand delivery (step S4). Specifically, the controller 12 may ask the user whether to change to hand delivery or to cancel delivery.

In a case in which the controller 12 does not change to hand delivery (step S4: NO), the controller 12 extracts positions serving as candidate delivery positions (step S5), taking into account that the delivery article 50 will be wet due to water. Specifically, controller 12 may extract candidate positions where the amount of water on the delivery article 50 will be less than an allowable value.

The controller 12 determines the delivery position (step S6). Specifically, in a case of extracting candidate positions in the procedure of step S5, the controller 12 determines the delivery position from among the extracted candidate positions. In a case in which it is determined in step S2 that there is no area with standing water or flowing water, and it is determined in step S3 that there is no precipitation and that the probability of precipitation is less than a predetermined value, the controller 12 may determine a position specified by the user as the delivery destination. The controller 12 controls the mobile object 40 to place the delivery article 50 at the determined delivery position (step S7).

In a case in which the controller 12 changes to hand delivery (step S4: YES), the controller 12 cancels the unattended delivery (step S8). After executing the procedure in step S7 or S8, the controller 12 ends the execution of the procedures in the flowchart of FIG. 3. The controller 12 may execute steps S2 and S3 in reverse order or in parallel.

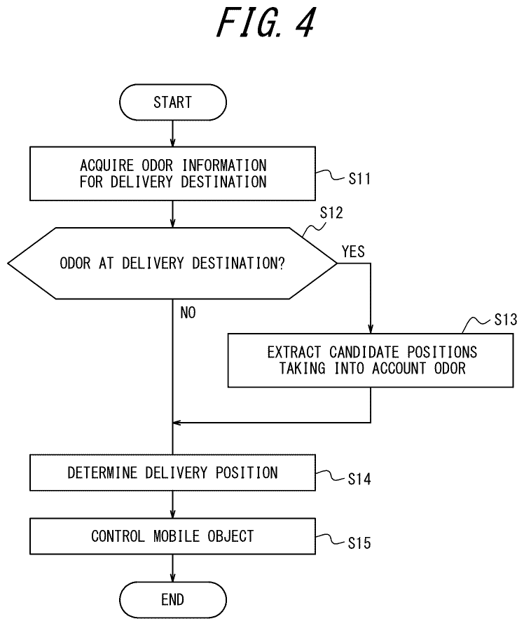

The controller 12 may, for example, perform a management method including the procedures of the flowchart illustrated in FIG. 4 to determine the delivery position taking into account the odor at the delivery destination. The management method may be implemented as a management program to be executed by the controller 12.

The controller 12 acquires information on an odor as the environmental information for the delivery destination (step S11). The controller 12 determines whether there is an odor at the delivery destination (step S12). In a case in which there is no odor at the delivery destination (step S12: NO), the controller 12 proceeds to step S14. In a case in which there is an odor at the delivery destination (step S12: YES), the controller 12 extracts positions serving as candidate delivery positions (step S13), taking into account that the odor will stick to the delivery article 50.

The controller 12 determines the delivery position (step S14). Specifically, in a case of extracting candidate positions in the procedure of step S13, the controller 12 determines the delivery position from among the extracted candidate positions. In a case in which it is determined that there is no odor in step S12, the controller 12 may determine a position specified by the user as the delivery position. The controller 12 controls the mobile object 40 to place the delivery article 50 at the determined delivery position (step S15). After executing the procedure in step S15, the controller 12 ends the execution of the procedures in the flowchart of FIG. 4.

### SUMMARY

As described above, according to the management system 1, the management apparatus 10, and the management method of the present embodiment, the delivery position is determined by taking into account the environment at the delivery destination in the case of unattended delivery. As a result, the effect of the environment on the delivery articles 50 placed at the delivery destination can be reduced.

### OTHER EMBODIMENTS

In the management system 1 according to the above embodiment, the mobile object controller 46 of the mobile object 40 controls the mobile object 40 to place the delivery article 50 at the delivery position determined by the management apparatus 10. In a management system 1 according to another embodiment, the mobile object controller 46 of the mobile object 40 may operate so that the mobile object 40 itself determines the delivery position when arriving at the delivery destination and places the delivery article 50. That is, the mobile object controller 46 may control the mobile object 40 to place the delivery article 50 at a position, as the delivery position, determined based on the environmental information for the delivery destination.

The mobile object controller 46 may acquire environmental information for the delivery destination from the detector 48 of the mobile object 40. The mobile object controller 46 may acquire information on the weather at the delivery destination from the detector 48. The mobile object controller 46 may acquire information representing a state of standing water or a state of flowing water at the delivery destination from the detector 48. The mobile object controller 46 may acquire information on an odor at the delivery destination from the detector 48.

The mobile object controller 46 may be configured to communicate with the detection apparatus 60 installed at the delivery destination. The mobile object controller 46 may acquire the environmental information for the delivery destination from the detection apparatus 60.

As described above, the mobile object 40 according to the present embodiment can determine the delivery position taking into account the environment at the delivery destination in the case of unattended delivery. As a result, the effect of the environment on the delivery articles 50 placed at the delivery destination can be reduced.

Examples of some embodiments of the present disclosure are described below. However, it should be noted that the embodiments of the present disclosure are not limited to these examples.

[Appendix 1] A management apparatus comprising a controller configured to manage a mobile object for delivering a delivery article by placing the delivery article at a delivery position, wherein
the controller is configured to determine the delivery position based on environmental information for a delivery destination and control the mobile object to place the delivery article at the delivery position.

[Appendix 2] The management apparatus according to appendix 1, wherein the controller is configured to determine the delivery position based on information on weather at the delivery destination as the environmental information for the delivery destination.

[Appendix 3] The management apparatus according to appendix 2, wherein the controller is configured to determine a location where an effect of precipitation is reduced as the delivery position in a case in which there is precipitation at the delivery destination or a case in which precipitation is predicted within a predetermined time at the delivery destination.

[Appendix 4] The management apparatus according to appendix 2 or 3, wherein the controller is configured to install a delivery container capable of storing the delivery article at the delivery destination and determine the delivery container as the delivery position in a case in which there is precipitation at the delivery destination or a case in which precipitation is predicted within a predetermined time at the delivery destination.

[Appendix 5] The management apparatus according to any one of appendices 2 to 4, wherein the controller is configured to control the mobile object not to place the delivery article at the delivery position based on a selection by a user who is to receive the delivery article in a case in which there is precipitation at the delivery destination or a case in which precipitation is predicted within a predetermined time at the delivery destination.

[Appendix 6] The management apparatus according to any one of appendices 1 to 5, wherein the controller is configured to determine the delivery position based on information representing a state of standing water or a state of flowing water as the environmental information for the delivery destination.

[Appendix 7] The management apparatus according to any one of appendices 1 to 6, wherein the controller is configured to determine the delivery position based on information representing whether there was standing water before or whether there was flowing water before as the environmental information for the delivery destination.

[Appendix 8] The management apparatus according to any one of appendices 1 to 7, wherein the controller is configured to determine the delivery position based on information on an odor at the delivery destination as the environmental information for the delivery destination.

[Appendix 9] The management apparatus according to appendix 8, wherein the controller is configured to determine a position at which the odor sticks less to the delivery article as the delivery position.

[Appendix 10] The management apparatus according to any one of appendices 1 to 9, wherein the controller is configured to determine the delivery position from a position designated by a user who is to receive the delivery article.

[Appendix 11] A management system comprising: the management apparatus according to any one of appendices 1 to 10; and a mobile object configured to deliver a delivery article by placing the delivery article at a delivery position.

[Appendix 12] A management method for managing a mobile object for delivering a delivery article by placing the delivery article at a delivery position, the management method comprising:
determining the delivery position based on environmental information for a delivery destination and controlling the mobile object to place the delivery article at the delivery position.

[Appendix 13] The management method according to appendix 12, further comprising determining the delivery position based on information on weather at the delivery destination as the environmental information for the delivery destination.

[Appendix 14] The management method according to appendix 13, further comprising determining a location where an effect of precipitation is reduced as the delivery position in a case in which there is precipitation at the delivery destination or a case in which precipitation is predicted within a predetermined time at the delivery destination.

[Appendix 15] The management method according to any one of appendices 12 to 14, further comprising determining the delivery position based on information on an odor at the delivery destination as the environmental information for the delivery destination.

[Appendix 16] A mobile object for delivering a delivery article by placing the delivery article at a delivery position, the mobile object comprising:
a controller configured to determine the delivery position based on environmental information for a delivery destination.

[Appendix 17] The mobile object according to appendix 16, further comprising a detector configured to detect the environmental information for the delivery destination.

[Appendix 18] The mobile object according to appendix 17, wherein the detector is configured to detect information on weather at the delivery destination as the environmental information for the delivery destination.

[Appendix 19] The mobile object according to appendix 17 or 18, wherein the detector is configured to detect information representing a state of standing water at the delivery destination or a state of flowing water at the delivery destination as the environmental information for the delivery destination.

[Appendix 20] The mobile object according to any one of appendices 17 to 19, wherein the detector is configured to detect information on an odor at the delivery destination as the environmental information for the delivery destination.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A management apparatus comprising a controller configured to manage a mobile object for delivering a delivery article by placing the delivery article at a delivery position, wherein
the controller is configured to determine the delivery position based on environmental information for a delivery destination and control the mobile object to place the delivery article at the delivery position.

2. The management apparatus according to claim 1, wherein the controller is configured to determine the delivery position based on information on weather at the delivery destination as the environmental information for the delivery destination.

3. The management apparatus according to claim 2, wherein the controller is configured to determine a location where an effect of precipitation is reduced as the delivery position in a case in which there is precipitation at the delivery destination or a case in which precipitation is predicted within a predetermined time at the delivery destination.

4. The management apparatus according to claim 2, wherein the controller is configured to install a delivery container capable of storing the delivery article at the delivery destination and determine the delivery container as the delivery position in a case in which there is precipitation at the delivery destination or a case in which precipitation is predicted within a predetermined time at the delivery destination.

5. The management apparatus according to claim 2, wherein the controller is configured to control the mobile object not to place the delivery article at the delivery position based on a selection by a user who is to receive the delivery article in a case in which there is precipitation at the delivery destination or a case in which precipitation is predicted within a predetermined time at the delivery destination.

6. The management apparatus according to claim 1, wherein the controller is configured to determine the delivery position based on information representing a state of standing water or a state of flowing water as the environmental information for the delivery destination.

7. The management apparatus according to claim 1, wherein the controller is configured to determine the delivery position based on information representing whether there was standing water before or whether there was flowing water before as the environmental information for the delivery destination.

8. The management apparatus according to claim 1, wherein the controller is configured to determine the delivery position based on information on an odor at the delivery destination as the environmental information for the delivery destination.

9. The management apparatus according to claim 8, wherein the controller is configured to determine a position at which the odor sticks less to the delivery article as the delivery position.

10. The management apparatus according to claim 1, wherein the controller is configured to determine the delivery position from a position designated by a user who is to receive the delivery article.

11. A management system comprising: the management apparatus according to claim 1; and a mobile object configured to deliver a delivery article by placing the delivery article at a delivery position.

12. A management method for managing a mobile object for delivering a delivery article by placing the delivery article at a delivery position, the management method comprising:
determining the delivery position based on environmental information for a delivery destination and controlling the mobile object to place the delivery article at the delivery position.

13. The management method according to claim 12, further comprising determining the delivery position based on information on weather at the delivery destination as the environmental information for the delivery destination.

14. The management method according to claim 13, further comprising determining a location where an effect of precipitation is reduced as the delivery position in a case in which there is precipitation at the delivery destination or a case in which precipitation is predicted within a predetermined time at the delivery destination.

15. The management method according to claim 12, further comprising determining the delivery position based on information on an odor at the delivery destination as the environmental information for the delivery destination.

16. A mobile object for delivering a delivery article by placing the delivery article at a delivery position, the mobile object comprising:
a controller configured to determine the delivery position based on environmental information for a delivery destination.

17. The mobile object according to claim 16, further comprising a detector configured to detect the environmental information for the delivery destination.

18. The mobile object according to claim 17, wherein the detector is configured to detect information on weather at the delivery destination as the environmental information for the delivery destination.

19. The mobile object according to claim 17, wherein the detector is configured to detect information representing a state of standing water at the delivery destination or a state of flowing water at the delivery destination as the environmental information for the delivery destination.

20. The mobile object according to claim 17, wherein the detector is configured to detect information on an odor at the delivery destination as the environmental information for the delivery destination.
